(19) United States
(12) Patent Application Publication
(10) Pub. No.: US 2023/0021101 A1
(43) Pub. Date: Jan. 19, 2023

(54) THERMOPLASTIC MOULDING COMPOSITION WITH GOOD DEMOULDING BEHAVIOUR

(71) Applicant: Covestro Intellectual Property GmbH & Co. KG, Leverkusen (DE)

(72) Inventors: Derk WANDNER, Odenthal (DE); Helmut Werner HEUER, Siegen (DE); Sascha LEIPNITZ, Moers (DE); Werner BISCHOFFS, Köln (DE)

(21) Appl. No.: 17/781,502

(22) PCT Filed: Dec. 10, 2020
(86) PCT No.: PCT/EP2020/085410

§ 371 Date: Jun. 1, 2022

(30) Foreign Application Priority Data
Dec. 17, 2019 (EP) 19216843.3

(51) Int. Cl. C08G 18/08; C08G 18/10; C08G 18/73; C08G 18/32

(52) U.S. Cl. CPC C08G 18/0895; C08G 18/10; C08G 18/73; C08G 18/3206

(57) ABSTRACT

The invention relates to a thermoplastic moulding composition comprising A) at least one thermoplastic polyurethane polymer obtainable by reacting at least the following constituent components: I) one or more aliphatic diisocyanates having a molecular weight of between 140 g/mol to 170 g/mol and II) one or more aliphatic diols having a molecular weight of between 62 g/mol to 120 g/mol, the constituent components used to produce the thermoplastic polyurethane polymer consisting of at least 95% by weight of one or more aliphatic diisocyanates I) and one or more aliphatic diols II), based on the total mass of the constituent components used, wherein the one or more aliphatic diisocyanates I) and the one or more aliphatic diols II) are present in a molar ratio in the range from 1:0:0.95 to 0.95:1.0, characterized in that the ratio (I) of the thermoplastic polyurethane polymer is in a range from 2.3 to 6, wherein (II) is the molar mass centrifugal agent and (III) is the molar mass average, in each case determined by gel permeation chromatography in hexafluoroisopropanol against polymethyl methacrylate as standard, also comprising B) at least one mould release agent. The invention also relates to the use of the moulding composition for producing mouldings and to the mouldings thereof.

The invention relates to a thermoplastic molding compound comprising a thermoplastic polyurethane and a demolding agent, to the use of the molding compound for production of moldings and to the moldings themselves.

Owing to their excellent physical properties, polyurethanes and especially thermoplastic polyurethanes have been used for a wide variety of different end uses for many years. However, in some fields of application, other plastics, for example polyamide plastics, are used because there are no polyurethanes having suitable physical properties available or these can be provided only with difficulty.

Polyurethanes formed from short-chain aliphatic diols and short-chain aliphatic isocyanates and polyisocyanates have properties comparable to or better than the polyamide plastics, for example with regard to the paintability of the plastic.

Various preparation processes for such polyurethanes are known.

O. Bayer (Angew. Chem. 1947, 59, 257-288) discloses the preparation of polyurethanes from aliphatic diisocyanates and aliphatic diols in a batchwise process, especially a polyurethane formed from hexamethylene 1,6-diisocyanate and butane-1,4-diol (Perlon U, Igamid U), which is obtained as a fine, sandy powder from a precipitation polymerization in dichlorobenzene.

DE728981 discloses the preparation of polyurethanes and polyureas in a solvent-containing or solvent-free batchwise process.

V. V. Korshak (Soviet Plastics 1961, 7, 12-15) discloses a semibatchwise laboratory process for preparation of a polyurethane from hexamethylene 1,6-diisocyanate and butane-1,4-diol. For this purpose, hexamethylene 1,6-diisocyanate is introduced dropwise into heated butane-1,4-diol, which leads to a brittle addition product.

However, the various possible reactions of the isocyanates are found to be disadvantageous in respect of the production of thermoplastic polyurethanes. By virtue of the polyaddition reaction between isocyanate and hydroxyl groups, molecular weights that suggest good mechanical properties are attained only at very high conversions. At high conversions, however, there is also a rise in the tendency to side reactions, for example the formation of allophanate, biuret or isocyanurate groups, which constitute branch points in the polymer structure and hence reduce the thermoplastic character or even, in the extreme case, result in thermosets (G. Oertel, Kunststoff-Handbuch [Plastics Handbook], vol. 7, 3rd ed., 1993, p. 12ff).

Therefore, the specific molecular structure and also the molar mass distribution are dependent on the preparation process. This dependence subsequently also affects the mechanical properties of the thermoplastic polyurethanes.

Thermoplastic polyurethanes based on short-chain aliphatic diols and short-chain aliphatic polyisocyanates have a comparatively low softening temperature compared to other thermoplastics. This is favorable on the one hand for the processing to give moldings, because no particularly high temperatures are thus needed for melting.

On the other hand, for the commercial utilization of thermoplastic molding compounds composed of the thermoplastic polyurethanes, production of moldings by customary methods, for example extrusion or injection molding, should be possible without problems. At the same time, it should be possible to produce entirely different specimen geometries in a large number of items and at high speed. For this purpose, it is absolutely essential that the specimens do not stick to the injection molds in an unwanted manner.

It was therefore an object of the present invention to provide a thermoplastic molding compound comprising a thermoplastic polyurethane which features improved demolding characteristics. A particular object was that of providing a thermoplastic molding compound comprising a thermoplastic polyurethane that has lower sticking friction and sliding friction on demolding from an injection mold.

It has been found that, surprisingly, a thermoplastic molding compound comprising

A) at least one thermoplastic polyurethane polymer obtainable by the reaction of at least the following formation components:
I) one or more aliphatic diisocyanates having a molecular weight of 140 g/mol to 170 g/mol and
II) one or more aliphatic diols having a molecular weight of 62 g/mol to 120 g/mol, wherein the formation components used for production of the thermoplastic polyurethane polymer consist to an extent of at least 95% by weight of one or more aliphatic diisocyanates I) and one or more aliphatic diols II), based on the total mass of the formation components used, where the one or more aliphatic diisocyanates I) and the one or more aliphatic diols II) are used in a molar ratio in the range from 1.0:0.95 to 0.95:1.0, characterized in that the ratio M̅_{z}/M̅_{w} of the thermoplastic polyurethane polymer is within a range from 2.3 to 6, where M̅_{z} is the centrifuge-average molar mass and M̅_{w} the mass average molar mass, in each case determined by gel permeation chromatography in hexafluoroisopropanol against polymethylmethacrylate as standard,
B) at least one demolding agent,
has the desired properties.

Component B is present in the molding compound preferably in a proportion of 0.01% to 1% by weight, further preferably 0.1% to 0.8% by weight.

Optionally, the molding compound, aside from components A and B, contains further polymer additives or further polymeric components as component C.

In a preferred embodiment, the compositions consisting to an extent of 80% by weight, further preferably to an extent of 90% by weight, especially preferably to an extent of 95% by weight and most preferably to an extent of 100% by weight of components A, B and C.

It was a further object of the invention to provide moldings comprising the thermoplastic molding compound.

### Component A

Component A is a thermoplastic polyurethane obtainable by the reaction of at least the following formation components:

I) one or more aliphatic diisocyanates having a molecular weight of 140 g/mol to 170 g/mol and
II) one or more aliphatic diols having a molecular weight of 62 g/mol to 120 g/mol,
wherein the formation components used to produce the thermoplastic polyurethane consist to an extent of at least 95% by weight of one or more aliphatic diisocyanates I) and one or more aliphatic diols II), based on the total mass of the formation components used, wherein the one or more aliphatic diisocyanates I) and the one or more aliphatic diols II) are used in a molar ratio in the range from 1.0:0.95 to 0.95:1.0, characterized in that the M̅_{z}/M̅_{w} ratio of the thermoplastic polyurethane polymer is within a range from 2.3 to 6, preferably within the range from 2.5 to 5.5, more preferably within the range from 2.5 to 5, where M̅_{z} is the centrifuge-average molar mass and M̅_{w} is the mass-average molar mass, each determined by gel permeation chromatography in hexafluoroisopropanol against polymethylmethacrylate as standard.

The thermoplastic polyurethanes used in the molding compounds of the invention may contain minor thermoset components in the polymer matrix, as result, for example, from allophanate structural elements, biuret structural elements or from the proportional use of triols or triisocyanates as monomers, but only such a degree that the thermoplastic properties of the polyurethanes of the invention are maintained. Typically, there is 0.05-5% by weight, preferably 0.1-5% by weight, more preferably 0.3-5% by weight, even more preferably 0.3-3% by weight, even more preferably 0.5-5% by weight, even more preferably 0.5-4% by weight, more preferably 0.5-3% by weight, even more preferably 0.5-2% by weight and most preferably 0.5-1% by weight of thermoset components, based on the total weight of the thermoplastic polymer of the invention.

Unless explicitly stated otherwise, all percentages are based on weight (% by weight). The unit “% by weight” is based here on the total weight of the respective system or the total weight of the respective component. For example, a copolymer may have a content of a particular monomer that is expressed in % by weight, in which case the percentages by weight would be based on the total weight of the copolymer.

The word “a” in the context of the present invention in association with countable parameters should be understood to mean the number “one” only when this is stated explicitly (for instance by the expression “exactly one”). When reference is made hereinafter to “a polyol”, for example, the word “a” should be regarded merely as the indefinite article and not the number “one”, meaning that an embodiment comprising a mixture of at least two polyols is also encompassed.

According to the invention, the terms “comprising” or “containing” preferably mean “consisting essentially of” and more preferably mean “consisting of”.

Unless explicitly stated otherwise, in the present invention, the centrifuge-average molar mass M̅_{z}, the mass-average molar mass M̅_{w} and x₉₀ are determined by means of gel permeation chromatography (GPC) using polymethylmethacrylate as standard. The sample to be analysed is dissolved in a solution of 3 g of potassium trifluoroacetate in 400 cubic centimetres of hexafluoroisopropanol (sample concentration about 2 mg/cubic centimetre), then applied via a pre-column at a flow rate of 1 cubic centimetre/minute and then separated by means of three series-connected chromatography columns, first by means of a 1000 Å PSS PFG 7 μm chromatography column, then by means of a 300 Å PSS PFG 7 μm chromatography column and lastly by means of a 100 Å PSS PFG 7 μm chromatography column. The detector used was a refractive index detector (RI detector).

The centrifuge-average molar mass (M̅_{z}) was calculated from the data obtained by the gel permeation chromatography measurement with the aid of the following equation:

$${\overline{M}}_{z} = \frac{{Σ}_{i} {n}_{i} {M}_{i}^{3}}{{Σ}_{i} {n}_{i} {M}_{i}^{2}}$$

in g/mol
where:
Mᵢ is the molar mass of the polymers of the fraction i, such that Mᵢ<Mᵢ₊₁ for all i, in g/mol,
nᵢ is the molar amount of the polymer of the fraction i, in mol.

The mass-average molar mass (M̅_{w}) was likewise calculated from the data obtained by the gel permeation chromatography measurement with the aid of the following equation:

$${\overline{M}}_{w} = \frac{{Σ}_{i} {n}_{i} {M}_{i}^{2}}{{Σ}_{i} {n}_{i} {M}_{i}}$$

in g/mol
where:
Mᵢ is the molar mass of the polymers of the fraction i, such that Mᵢ<Mᵢ₊₁ for all i, in g/mol,
nᵢ is the molar amount of the polymer of the fraction i, in mol.

In a preferred embodiment, the M̅_{z}/M̅_{w} ratio of the thermoplastic polyurethane polymer is within a range from 2.5 to 5.5, preferably within a range from 2.5 to 5.

In a preferred embodiment, the M̅_{z} value of the thermoplastic polyurethane polymer is within a range of 100 000 g/mol to 900 000 g/mol, preferably within a range from 100 000 g/mol to 850 000 g/mol, more preferably within a range from 110 000 g/mol to 800 000 g/mol and even more preferably within a range from 120 000 g/mol to 760 000 g/mol, determined by gel permeation chromatography in hexafluoroisopropanol against polymethylmethacrylate as standard.

In a further preferred embodiment, the M̅_{z} of the thermoplastic polyurethane polymer is within a range from 80 000 g/mol to 900 000 g/mol, preferably within a range from 80 000 g/mol to 850 000 g/mol, more preferably within a range from 85 000 g/mol to 800 000 g/mol and even more preferably within a range from 85 000 g/mol to 760 000 g/mol, determined by gel permeation chromatography in hexafluoroisopropanol against polymethylmethacrylate as standard.

In a preferred embodiment, the thermoplastic polyurethane polymer consists to an extent of at least %% by weight, preferably to an extent of at least 97% by weight, more preferably to an extent of at least 98% by weight, even more preferably to an extent of at least 99% by weight, even more preferably still to an extent of at least 99.5% by weight and most preferably to an extent of at least 99.9% by weight of one or more aliphatic diisocyanates I) and one or more aliphatic diols II), based on the total mass of the polyurethane polymer.

Suitable aliphatic diisocyanates I) are all monomeric aliphatic diisocyanates known to the person skilled in the art that have a molecular weight of 140 g/mol to 170 g/mol. It is immaterial here whether the diisocyanates have been obtained by means of phosgenation or by a phosgene-free process. The diisocyanates and/or the precursor compounds of these may have been obtained from fossil or biological sources. Preference is given to preparing 1,6-diisocyanatohexane (HDI) from hexamethylene-1,6-diamine and 1,5-diisocyanatopentane from pentamethylene-1,5-diamine, with hexamethylene-1,6-diamine and pentamethylene-1,5-diamine having been obtained from biological sources, preferably by bacterial fermentation. The aliphatic diisocyanates for formation of the thermoplastic polyurethane polymer of the invention are preferably selected from the group consisting of 1,4-diisocyanatobutane (BDI), 1,5-diisocyanatopentane (PDI), 1,6-diisocyanatohexane (HDI) and 2-methyl-1,5-diisocyanatopentane or a mixture of at least two of these.

In a preferred embodiment, the one or more aliphatic diisocyanates I) are selected from the group consisting of 1,4-diisocyanatobutane, 1,5-diisocyanatopentane, 1,6-diisocyanatohexane, 2-methyl-1,5-diisocyanatopentane and/or mixtures of at least two of these. In another preferred embodiment, 1,5-diisocyanatopentane and/or 1,6-diisocyanatohexane are used as aliphatic diisocyanates I). In a further preferred embodiment, solely 1,6-diisocyanatohexane is used as aliphatic diisocyanate I).

Suitable aliphatic diols II) are all organic diols known to the person skilled in the art that have a molecular weight of 62 g/mol to 120 g/mol. The diols and/or precursor compounds thereof may have been obtained from fossil or biological sources. The aliphatic diols for formation of the thermoplastic polyurethane polymer of the invention are preferably selected from the group consisting of ethane-1,2-diol, propane-1,2-diol, propane-1,3-diol, butane-1,2-diol, butane-1,3-diol, butane-1,4-diol, pentane-1,2-diol, pentane-1,3-diol, pentane-1,4-diol, pentane-1,5-diol, hexane-1,2-diol, hexane-1,3-diol, hexane-1,4-diol, hexane-1,5-diol, hexane-1,6-diol or mixtures of at least two of these.

In a preferred embodiment, the one or more aliphatic diols II) are selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol and/or mixtures of at least two of these. In a further preferred embodiment, propane-1,3-diol, butane-1,4-diol, hexane-1,6-diol and/or mixtures of at least two of these are used as aliphatic diols II). In a further preferred embodiment, butane-1,4-diol and/or hexane-1,6-diol are used as aliphatic diols II). In another preferred embodiment, solely butane-1,4-diol is used as aliphatic diol.

In a further preferred embodiment, the thermoplastic polyurethane polymer is obtainable by the reaction of at least the following formation components:

I) one or more aliphatic diisocyanates selected from the group consisting of 1,4-diisocyanatobutane, 1,5-diisocyanatopentane, 1,6-diisocyanatohexane, 2-methyl-1,5-diisocyanatopentane and/or mixtures of at least two of these and
II) one or more aliphatic diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol or mixtures of at least two of these,
wherein the formation components used to produce the thermoplastic polyurethane polymer consist to an extent of at least 95% by weight, preferably to an extent of at least 98% by weight, more preferably to an extent of at least 99% by weight, even more preferably to an extent of 99.5% by weight, of one or more aliphatic diisocyanates I) and one or more aliphatic diols II), based on the total mass of the formation components used, wherein the one or more aliphatic diisocyanates I) and the one or more aliphatic diols II) are used in a molar ratio in the range from 1.0:0.95 to 0.95:1.0, characterized in that the M̅_{z}/M̅_{w} ratio of the thermoplastic polyurethane polymer is within a range from 2.3 to 6, where M̅_{z} is the centrifuge-average molar mass and M̅_{w} is the mass-average molar mass, each determined by gel permeation chromatography in hexafluoroisopropanol against polymethylmethacrylate as standard.

Further formation components used for production of the thermoplastic polyurethane polymers may, as well as the at least one or more than one aliphatic diisocyanate I) and the one or more than one aliphatic diol II), also be one or more polyisocyanates III) and/or one or more further NCO-reactive compounds IV). These further formation components III) and/or IV) are different from the formation components I) and II) and may be used in an amount of 0% by weight to 5% by weight. In a preferred embodiment, the formation components used for production of the thermoplastic polyurethane polymer consist to an extent of 0.1% by weight to 5% by weight of one or more polyisocyanates III) and/or one or more NCO-reactive compounds IV), based on the total mass of the formation components used. The isocyanate components I) and optionally III) are used with the isocyanate-reactive components II) and optionally IV) in a molar ratio of isocyanate component:isocyanate-reactive component in the range from 1.0:0.95 to 0.95:1.0.

In a further preferred embodiment, the thermoplastic polyurethane polymer is obtainable by the reaction of at least the following formation components:

I) one or more aliphatic diisocyanates having a molecular weight of 140 g/mol to 170 g/mol,
II) one or more aliphatic diols having a molecular weight of 62 g/mol to 120 g/mol,
III) one or more polyisocyanates, and/or
IV) one or more NCO-reactive compounds,
wherein the formation components used to produce the thermoplastic polyurethane polymer consist to an extent of at least 95% by weight of one or more aliphatic diisocyanates I) and one or more aliphatic diols II) and to an extent of ≤5% by weight of one or more polyisocyanates III) and/or one or more NCO-reactive compounds IV), based on the total mass of the formation components used.

Suitable polyisocyanates III) for formation of the polyurethane polymer of the invention are all aliphatic, cycloaliphatic, aromatic and aliphatic di- and triisocyanates that are known per se to the person skilled in the art, it being immaterial whether these have been obtained by means of phosgenation or by phosgene-free methods. The polyisocyanates and/or the precursor compounds thereof may have been obtained from fossil or biological sources. In addition, it is also possible to use the following higher molecular weight conversion products that are well known per se to the person skilled in the art: higher molecular weight conversion products (oligo- and polyisocyanates and prepolymers having NCO groups, especially polyurethane prepolymers having NCO groups) of monomeric di- and/or triisocyanates having urethane, urea, carbodiimide, acylurea, isocyanurate, allophanate, biuret, oxadiazinetrione, uretdione, iminooxadiazinedione structure, each individually or in any mixtures with one another. Preferred polyisocyanates III) are monomeric diisocyanates having a molecular weight of ≥140 to ≥400 g/mol.

Examples of suitable aliphatic diisocyanates are 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,8-diisocyanatooctane and 1,10-diisocyanatodecane.

Examples of suitable cycloaliphatic diisocyanates are 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H12MDI), 1,3- and 1,4-bis(isocyanatomethyl)cyclohexane, bis(isocyanatomethyl)norbornane (NBDI), 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane and 1,3-dimethyl-5,7-diisocyanatoadamantane.

Examples of suitable aromatic diisocyanates are 2,4- and 2,6-diisocyanatotoluene (TDI), 2,4′- and 4,4′-diisocyanatodiphenylmethane (MDI) and 1,5-diisocyanatonaphthalene.

Examples of suitable araliphatic diisocyanates are 1,3- and 1,4-bis(isocyanatomethyl)benzene (xylylene diisocyanate; XDI), 1,3- and 1,4-bis(1-isocyanato-1-methylethyl)benzene (TMXDI).

Examples of suitable triisocyanates are triphenylmethane 4,4′,4″-triisocyanate or 4-isocyanatomethyloctane 1,8-diisocyanate (TIN).

Further diisocyanates that are likewise suitable can additionally be found, for example, in Houben-Weyl “Methoden der organischen Chemie” [Methods of Organic Chemistry], volume E20 “Makromolekulare Stoffe” [Macromolecular Materials], Georg Thieme Verlag, Stuttgart, N.Y. 1987, pp. 1587-1593 or in Justus Liebigs Annalen der Chemie volume 562 (1949) pp. 75-136.

Suitable NCO-reactive compounds IV) for formation of the polyurethane polymer of the invention are all organic compounds that are known per se to the person skilled in the art and have at least two isocyanate-reactive (NCO-reactive) groups (NCO-reactive compound or isocyanate-reactive compound). In the context of the present invention, NCO-reactive groups are considered to be especially hydroxyl, amino or thio groups. For the purposes of the invention, it is also possible to use a mixture of different NCO-reactive compounds for formation of the at least one further structural element (S).

NCO-reactive compounds IV) used may be all systems having an average of at least 1.5, preferably 2 to 3 and more preferably 2 NCO-reactive groups.

Suitable isocyanate-reactive compounds are, for example, aliphatic, araliphatic or cycloaliphatic diols, organic triols, polyester polyols, polyether polyols, polycarbonate polyols, poly(meth)acrylate polyols, polyurethane polyols and polyamines.

Examples of aliphatic, araliphatic or cycloaliphatic diols are ethane-1,2-diol, propane-1,2-diol, propane-1,3-diol, butane-1,2-diol, butane-1,3-diol, butane-1,4-diol, pentane-1,5-diol, hexane-1,6-diol, heptane-1,7-diol, octane-1,8-diol, nonane-1,9-diol, decane-1,10-diol, undecane-1,11-diol, dodecane-1,12-diol, cyclobutane-1,3-diol, cyclopentane-1,3-diol, cyclohexane-1,2-, -1,3- and -1,4-diol, cyclohexane-1,4-dimethanol, 2-cyclohexene-1,4-diol, 2-methylcyclohexane-1,4-diol, 2-ethylcyclohexane-1,4-diol, 2,2,4,4-tetramethylcyclobutane-1,3-diol, hydrogenated bisphenol A (2,2-bis(4-hydroxycyclohexyl)propane), cycloheptane-1,3-diol, cycloheptane-1,4-diol, 2-methylcycloheptane-1,4-diol, 4-methylcycloheptane-1,3-diol, 4,4′-(1-methylethylidene)biscyclohexanol, cyclooctane-1,3-diol, cyclooctane-1,4-diol, cyclooctane-1,5-diol, 5-methylcyclooctane-1,4-diol, 5-ethylcyclooctane-1,4-diol, 5-propylcyclooctane-1,4-diol, 5-butylcyclooctane-1,4-diol and benzene-1,2-dimethanol.

Examples of organic triols are glycerol and trimethylolpropane.

Preference is given to using aliphatic, araliphatic or cycloaliphatic diols having molecular weights of 62 g/mol to 250 g/mol.

Suitable polyester polyols can be prepared in a known manner by polycondensation of low molecular weight polycarboxylic acid derivatives, for example succinic acid, adipic acid, suberic acid, azelaic acid, sebacic acid, dodecanedioic acid, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid, trimer fatty acid, phthalic acid, phthalic anhydride, isophthalic acid, terephthalic acid, citric acid or trimellitic acid, with low molecular weight polyols, for example ethylene glycol, diethylene glycol, neopentyl glycol, hexanediol, butanediol, 1,4-dihydroxycyclohexane, 1,4-dimethylolcyclohexane, propylene glycol, glycerol, trimethylolpropane, 1,4-hydroxymethylcyclohexane, 2-methylpropane-1,3-diol, butane-1,2,4-triol, triethylene glycol, tetraethylene glycol, polyethylene glycol, dipropylene glycol, polypropylene glycol, dibutylene glycol and polybutylene glycol, or by ring-opening polymerization of cyclic carboxylic esters such as ε-caprolactone. In addition, it is also possible to polycondense hydroxycarboxylic acid derivatives, for example lactic acid, cinnamic acid or ω-hydroxycaproic acid, to give polyester polyols. However, it is also possible to use polyester polyols of oleochemical origin. Such polyester polyols can be prepared, for example, by full ring-opening of epoxidized triglycerides of an at least partly olefinically unsaturated fatty acid-containing fat mixture with one or more alcohols having 1 to 12 carbon atoms and by subsequent partial transesterification of the triglyceride derivatives to alkyl ester polyols having 1 to 12 carbon atoms in the alkyl radical.

Suitable polyether polyols are obtainable in a manner known per se by alkoxylation of suitable starter molecules under base catalysis or by the use of double metal cyanide compounds (DMC compounds). The polyether polyols are polyaddition products, optionally of blockwise construction, of cyclic ethers onto OH- or NH-functional starter molecules. Suitable cyclic ethers are, for example, styrene oxides, ethylene oxide, propylene oxide, tetrahydrofuran, butylene oxide, epichlorohydrin and any desired mixtures thereof. Starter molecules used may be the polyhydric alcohols of OH functionality ≥2 mentioned above in the context of the discussion of the polyester polyols, and also primary or secondary amines and amino alcohols. Suitable and preferred polyether polyols are di-, tri- and tetraethylene glycol, and di-, tri- and tetrapropylene glycol.

Suitable polycarbonate polyols are obtainable in a manner known per se by reacting organic carbonates or phosgene with diols or diol mixtures. Organic carbonates suitable for the purpose are, for example, dimethyl carbonate, diethyl carbonate and diphenyl carbonate. Suitable polyhydric alcohols include the polyhydric alcohols of OH functionality ≥2 mentioned above in the context of the discussion of the polyester polyols. Preference is given to using butane-1,4-diol, hexane-1,6-diol and/or 3-methylpentanediol. Polyester polyols may also be transformed to polycarbonate polyols. Particular preference is given to using dimethyl carbonate or diethyl carbonate in the conversion of the alcohols mentioned to polycarbonate polyols.

Suitable polyacrylate polyols are generally copolymers and preferably have mass-average molecular weights Mw between 1000 and 10 000 daltons. The preparation of suitable polyacrylate polyols is known to the person skilled in the art. They are obtained by free-radical polymerization of olefinically unsaturated monomers having hydroxyl groups or by free-radical copolymerization of olefinically unsaturated monomers having hydroxyl groups with optionally other olefinically unsaturated monomers, for example ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, amyl acrylate, amyl methacrylate, hexyl acrylate, hexyl methacrylate, ethylhexyl acrylate, ethylhexyl methacrylate, 3,3,5-trimethylhexyl acrylate, 3,3,5-trimethylhexyl methacrylate, stearyl acrylate, stearyl methacrylate, lauryl acrylate or lauryl methacrylate, cycloalkyl acrylates and/or cycloalkyl methacrylates, such as cyclopentyl acrylate, cyclopentyl methacrylate, isobornyl acrylate, isobornyl methacrylate or especially cyclohexyl acrylate and/or cyclohexyl methacrylate. Suitable olefinically unsaturated monomers having hydroxyl groups are especially 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate and especially 4-hydroxybutyl acrylate and/or 4-hydroxybutyl methacrylate. Further monomer units used for the polyacrylate polyols may be vinylaromatic hydrocarbons, such as vinyltoluene, alpha-methylstyrene or especially styrene, amides or nitriles of acrylic acid or methacrylic acid, vinyl esters or vinyl ethers, and in minor amounts especially acrylic acid and/or methacrylic acid.

Suitable polyurethane polyols are, for example, hydroxy-terminated prepolymers formed from the above-described diisocyanates and diols. As well as urethane groups, the polyurethane polyols may also contain urea, carbodiimide, acylurea, isocyanurate, allophanate, biuret, oxadiazinetrione, uretdione, iminooxadiazinedione structures. The polyurethane polyols are preparable by reaction of diisocyanates with of diols by preparation processes known to the person skilled in the art.

Examples of polyamines are ethylenediamine, 1,2-diaminopropane, 1,4-diaminobutane, 2-methylpentamethylenediamine, 1,6-diaminohexane, 2,2,4- or 2,4,4-trimethylhexamethylenediamine, 1,2-diaminocyclohexane, 1-amino-3,3,5-trimethyl-5-aminomethylcyclohexane (isophoronediamine, IPDA), 4,4′-diaminodicyclohexylmethane, polyaspartic esters as obtainable, for example, by the process of EP-B 0 403 921 by reaction of diamines with fumaric or maleic esters, or else polyether polyamines having aliphatically bonded primary amino groups.

The reaction of formation components I), II), optionally III) and/or optionally IV) for production of the polyurethane polymer of the invention may take place in the presence of one or more catalysts.

Suitable catalysts are the customary tertiary amines known from the prior art, for example triethylamine, dimethylcyclohexylamine, N-methylmorpholine, N,N′-dimethylpiperazine, 2-(dimethylaminoethoxy)ethanol, diazabicyclo[2.2.2]octane and the like, and also in particular organic metal compounds such as titanic esters, iron compounds, tin compounds, e.g. tin diacetate, tin dioctoate, tin dilaurate or the dialkyltin salts of aliphatic carboxylic acids such as dibutyltin diacetate, dibutyltin dilaurate or the like. Preferred catalysts are organic metal compounds, in particular titanic esters, iron compounds and/or tin compounds.

The catalyst is used in amounts of 0.001% to 2.0% by weight, preferably of 0.005% to 1.0% by weight, more preferably of 0.01% to 0.1% by weight, based on the diisocyanate component. The catalyst can be used in neat form or dissolved in the diol component. One advantage here is that the thermoplastic polyurethanes that are then obtained do not contain any impurities as a result of any solvents for the catalyst that are used in addition. The catalyst can be added in one or more portions or else continuously, for example with the aid of a suitable metering pump, over the entire duration of the reaction.

Alternatively, it is also possible to use mixtures of the catalyst(s) with a catalyst solvent, preferably with an organic catalyst solvent. The degree of dilution of the catalyst solutions can be chosen freely within a very wide range. Catalytically active solutions are those of a concentration over and above 0.001% by weight.

Suitable solvents for the catalyst are, for example, solvents that are inert toward isocyanate groups, for example hexane, toluene, xylene, chlorobenzene, ethyl acetate, butyl acetate, diethylene glycol dimethyl ether, dipropylene glycol dimethyl ether, ethylene glycol monomethyl or monoethyl ether acetate, diethylene glycol ethyl and butyl ether acetate, propylene glycol monomethyl ether acetate, 1-methoxy-2-propyl acetate, 3-methoxy-n-butyl acetate, propylene glycol diacetate, acetone, methyl ethyl ketone, methyl isobutyl ketone, cyclohexanone, lactones, such as β-propiolactone, γ-butyrolactone, ε-caprolactone and ε-methylcaprolactone, but also solvents such as N-methylpyrrolidone and N-methylcaprolactam, 1,2-propylene carbonate, methylene chloride, dimethyl sulfoxide, triethyl phosphate or any desired mixtures of such solvents.

Alternatively, it is possible to use solvents for the catalyst that bear groups reactive toward isocyanates and can be incorporated into the diisocyanate. Examples of such solvents are mono- and polyhydric simple alcohols, for example methanol, ethanol, n-propanol, isopropanol, n-butanol, n-hexanol, 2-ethyl-1-hexanol, ethylene glycol, propylene glycol, the isomeric butanediols, 2-ethylhexane-1,3-diol or glycerol; ether alcohols, for example 1-methoxy-2-propanol, 3-ethyl-3-hydroxymethyloxetane, tetrahydrofurfuryl alcohol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol, dipropylene glycol or else liquid higher molecular weight polyethylene glycols, polypropylene glycols, mixed polyethylene/polypropylene glycols and the monoalkyl ethers thereof; ester alcohols, for example ethylene glycol monoacetate, propylene glycol monolaurate, glycerol mono- and diacetate, glycerol monobutyrate or 2,2,4-trimethylpentane-1,3-diol monoisobutyrate; unsaturated alcohols, for example allyl alcohol, 1,1-dimethyl allyl alcohol or oleyl alcohol; araliphatic alcohols, for example benzyl alcohol; N-monosubstituted amides, for example N-methylformamide, N-methylacetamide, cyanoacetamide or 2-pyrrolidone, or any desired mixtures of such solvents.

In a further preferred embodiment, the thermoplastic polyurethane polymer of the invention is obtainable by the reaction of at least the following formation components:

I) one or more aliphatic diisocyanates selected from the group consisting of 1,4-diisocyanatobutane, 1,5-diisocyanatopentane, 1,6-diisocyanatohexane, 2-methyl-1,5-diisocyanatopentane and/or mixtures of at least two of these,
II) one or more aliphatic diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol or mixtures of at least two of these,
III) one or more monomeric diisocyanates having a molecular weight of 140 g/mol to 400 g/mol,
IV) one or more NCO-reactive compounds selected from the group consisting of aliphatic diols, araliphatic diols, cycloaliphatic diols, organic triols, polyester polyols, polyether polyols, polycarbonate polyols, poly(meth)acrylate polyols, polyurethane polyols, polyamines and/or mixtures of at least two of these,
wherein the formation components used to produce the thermoplastic polyurethane polymer consist to an extent of 95% by weight to 99.9% by weight of one or more aliphatic diisocyanates I) and one or more aliphatic diols II) and to an extent of 0.1% by weight to 5% by weight of one or more diisocyanates III) and/or one or more NCO-reactive compounds IV), based on the total mass of the formation components used, where the diisocyanate components I) and optionally III) are used with the NCO-reactive components II) and optionally IV) in a molar ratio of diisocyanate component:NCO-reactive component in the range from 1.0:0.95 to 0.95:1.0, characterized in that the M̅_{z}/M̅_{w} ratio of the thermoplastic polyurethane polymer is within a range from 2.3 to 6, where M̅_{z} is the centrifuge-average molar mass and M̅_{w} is the mass-average molar mass, each determined by gel permeation chromatography in hexafluoroisopropanol against polymethylmethacrylate as standard.

In a further preferred embodiment, the thermoplastic polyurethane polymer of the invention is obtainable by the reaction of at least the following formation components:

I) 1,6-diisocyanatohexane and
II) butane-1,4-diol,
III) one or more monomeric diisocyanates having a molecular weight of 140 g/mol to 400 g/mol,
IV) one or more NCO-reactive compounds selected from the group consisting of aliphatic, araliphatic or cycloaliphatic diols having molecular weights of 62 g/mol to 250 g/mol and/or mixtures of at least two of these,
wherein the formation components used to produce the thermoplastic polyurethane polymer consist to an extent of 95% by weight to 99.9% by weight of 1,6-diisocyanatohexane I) and butane-1,4-diol II) and to an extent of 0.1% by weight to 5% by weight of one or more diisocyanates III) and/or one or more NCO-reactive compounds IV), based on the total mass of the formation components used, where the diisocyanate components I) and optionally III) are used with the NCO-reactive components II) and optionally IV) in a molar ratio of diisocyanate component:NCO-reactive component in the range from 1.0:0.95 to 0.95:1.0, characterized in that the M̅_{z}/M̅_{w} ratio of the thermoplastic polyurethane polymer is within a range from 2.3 to 6, where M̅_{z} is the centrifuge-average molar mass and M̅_{w} is the mass-average molar mass, each determined by gel permeation chromatography in hexafluoroisopropanol against polymethylmethacrylate as standard.

In a preferred embodiment, the thermoplastic polyurethane polymer of the invention has a urethane group content of 40% by weight to 60% by weight, preferably of 40% by weight to 52% by weight, based on the total weight of the thermoplastic polyurethane polymer. In a particularly preferred embodiment, the thermoplastic polyurethane polymer of the invention has a urethane group content of 44% by weight to 48% by weight, even more preferably of 44% by weight to 46% by weight, based on the total weight of the thermoplastic polyurethane polymer.

The urethane group content is determined by dividing the mass of the (theoretical) linear repeat unit by the mass of the urethane structural unit. In this case, each isocyanate group (—NCO) is reacted with an alcohol group (—OH). The resulting value is multiplied by 100 in order to obtain a value in %.

### Example Calculation:

| | | Mass in g/mol |
|---|---|---|
| Diisocyanate | pentamethylene 1,5- | 154.17 |
| | diisocyanate | |
| Diol | butane-1,4-diol | 90.12 |
| Repeat unit | | 244.29 |
| Urethane group | | 59.02 |

Number of urethane groups theoretically present=2
Resulting urethane group density=48.32.

In a preferred embodiment, the thermoplastic polyurethane polymer of the invention has a percent by weight ratio of O to N determined by means of elemental analysis of ≥1.5:1 to ≤2.6:1 and a weight ratio of N to C determined by means of elemental analysis of ≥1:10 to ≤1:3.

In a further preferred embodiment, the thermoplastic polyurethane polymer of the invention is a semicrystalline thermoplastic polyurethane polymer.

In a further preferred embodiment, the thermoplastic polyurethane polymer of the invention has a glass transition point of <50° C., preferably in the range between ≥0° C. and <50° C., determined by means of differential scanning calorimetry to DIN EN 61006 (November 2004).

In a further preferred embodiment, the thermoplastic polyurethane polymer of the invention has a melting point of >150° C., more preferably between 150° C. and 200° C., determined by means of differential scanning calorimetry to DIN EN 61006 (November 2004).

In a further preferred embodiment, the thermoplastic polyurethane polymer of the invention has at least 100° C. between the glass transition point determined by means of differential scanning calorimetry to DIN EN 61006 (November 2004) and the melting point determined by means of differential scanning calorimetry to DIN EN 61006 (November 2004) of the thermoplastic polyurethane.

The preparation of the thermoplastic polyurethane polymer can be effected, for example, in a multistage process, wherein, in at least one stage, at least one prepolymer, preferably a hydroxy-terminated prepolymer, is formed from at least one aliphatic diisocyanate I) having a molecular weight of 140 g/mol to 170 g/mol and at least one aliphatic diol II) having a molecular weight of 62 g/mol to 120 g/mol. Further formation components used may be one or more polyisocyanates III) and/or one or more NCO-reactive compounds IV). Components III) and IV) may be incorporated into the prepolymers, prepolymers can be produced solely therefrom and/or they can be used to link the prepolymers. Components I), II), optionally III) and optionally IV) are each selected independently of one another. The isocyanate components I) and optionally III) are used with the isocyanate-reactive components II) and optionally IV) in a molar ratio of isocyanate component:isocyanate-reactive component in the range from 1.0:0.95 to 0.95:1.0.

In the context of the present invention, a “hydroxy-terminated prepolymer” is understood to mean a prepolymer mixture in which at least 90% (by number) of the ends of the molecule have a hydroxyl group and the remaining 10% (by number) of ends of the molecule have further hydroxyl groups, NCO groups or non-reactive groups. A “non-reactive group” in the context of the present invention is understood as meaning a group that, under the reaction conditions of the invention, reacts neither with NCO groups nor with OH groups within a unit of time that corresponds to the reaction time of the invention. A non-reactive group can be converted, for example, from a reactive NCO group or OH group by reaction with suitable co-reactants (chain terminator) to a non-reactive group. Suitable chain terminators are all monofunctional compounds that react under the reaction conditions of the invention either with an isocyanate group or with a hydroxy group, for example monoalcohols such as methanol, monoamines such as diethylamine, and monoisocyanates such as butyl isocyanate. The hydroxy-terminated prepolymer may have, for example, a hydroxy group at one end of the molecule and, for example, an alkyl group at the other end(s) of the molecule. Where reference is made to a hydroxy-terminated prepolymer in the context of the present invention, this always means a mixture of the at least one hydroxy-terminated prepolymer and a non-reactively terminated prepolymer. In addition, on the basis of the statistics of the reaction, disregarding side reactions, it may also be a mixture of non-hydroxy-terminated up to doubly hydroxy-terminated prepolymers. Preferably, it is predominantly a mixture of doubly hydroxy-terminated prepolymers. According to the invention, the at least one hydroxy-terminated prepolymer may also be a mixture of at least one hydroxy-terminated prepolymer and at least one non-reactively terminated prepolymer.

The at least one hydroxy-terminated prepolymer may be formed, for example, from the entirety of the aliphatic diols II) and a first portion of the aliphatic diisocyanates I). In one or more subsequent steps, further portions of the aliphatic diisocyanates I), i.e. a second, third etc. portion, may then be added in order to form further hydroxy-terminated prepolymers of the invention, generally of higher molecular weight. Alternatively, the at least one hydroxy-terminated prepolymer may be formed, for example, from a first portion of the aliphatic diols II) and a first portion of the aliphatic diisocyanates I). In one or more subsequent process stages, further portions of the aliphatic diols II) and of the aliphatic diisocyanates I) may then be fed in in order to form further hydroxy-terminated prepolymers, generally of higher molecular weight.

The reaction can be performed with or without catalyst, but preference is given to a catalysed reaction. Suitable catalysts are the catalysts listed above. The reaction can be effected in a solvent-free manner or in solution. What is meant by “in solution” is that at least one of the co-reactants is dissolved in a solvent before being added to the other co-reactant. Preference is given to performing the reaction in a solvent-free manner. In the context of the present invention, the process is still considered to be solvent-free when the solvent content is up to 1% by weight, preferably up to 0.1% by weight, even more preferably up to 0.01% by weight, based on the total weight of the reaction mixture.

The temperatures for formation of the at least one prepolymer, preferably hydroxy-terminated prepolymer, by the process of the invention can be selected depending on the compounds used. However, it is preferable here when the reaction is conducted at temperatures of ≥40° C. to ≤260° C., preferably of ≥60° C. to ≤250° C., more preferably of ≥100° C. to ≤240° C., especially preferably of ≥120° C. to ≤220° C. In this context, brief (<60 seconds) deviations in the reaction temperature from the abovementioned ranges experienced by the product during the reaction are tolerated.

The at least one prepolymer thus produced, preferably hydroxy-terminated prepolymer, may, for example, be reacted in at least one further process stage with at least one chain extender to give the thermoplastic polyurethane polymer. It is possible here to react either the entireties of the two components, i.e. of the at least one prepolymer generated, preferably hydroxy-terminated prepolymer, and of the at least one chain extender, with one another in one process stage, or to react a portion of one component with the entirety or a portion of the other component in multiple process stages. Chain extenders used may be any of the abovementioned polyisocyanates. Preference is given to using one or more aliphatic diisocyanates having a molecular weight of 140 g/mol to 170 g/mol as chain extender.

If the thermoplastic polyurethane polymer of the invention is to have aromatic groups, for example, these may be introduced, for example, through the use of aromatic diisocyanates as chain extender. It is also possible, for example, to produce aromatic prepolymers and to mix these with the aliphatic prepolymers in order to form polyurethane polymers of the invention that have aromatic groups.

The reaction of components I), II), optionally III) and optionally IV) can be performed with or without catalyst, although a catalysed reaction is less preferred. Suitable catalysts are the catalysts listed above. The reaction can be effected in a solvent-free manner or in solution. What is meant by “in solution” is that at least one of the co-reactants is dissolved in a solvent before being added to the other co-reactant. Preference is given to performing the reaction in a solvent-free manner. In the context of the present invention, the process is still considered to be solvent-free when the solvent content is up to 1% by weight, preferably up to 0.1% by weight, even more preferably up to 0.01% by weight, based on the total weight of the reaction mixture.

The temperatures for formation of the thermoplastic polyurethane polymer of the invention by reaction of the at least one prepolymer, preferably hydroxy-terminated prepolymer, with the at least one chain extender in the process of the invention may be selected depending on the compounds used. However, it is preferable here when the reaction is conducted at temperatures of ≥60° C. to ≤260° C., preferably of ≥80° C. to ≤250° C., more preferably of ≥100° C. to ≤245° C. and most preferably of ≥120° C. to ≤240° C. In this context, brief (<60 seconds) deviations in the reaction temperature from the abovementioned ranges experienced by the product during the reaction are tolerated.

If the at least one prepolymer, preferably hydroxy-terminated prepolymer, or the thermoplastic polyurethane polymer has a tendency to crystallize and has a melting point, the reaction is preferably conducted within a temperature range from 30 K below to 150 K above the melting point, preferably from 15 K below to 100 K above, more preferably from 10 K below to 70 K above, the melting point of the at least one prepolymer, preferably hydroxy-terminated prepolymer, or the thermoplastic polyurethane.

The process stages for production of the thermoplastic polyurethane polymer of the invention can be performed in a single apparatus or in a multitude of apparatuses. For example, the production of the prepolymer, preferably hydroxy-terminated prepolymer, can first be conducted in a first apparatus (e.g. loop reactor or coolable mixer) and then the reaction mixture can be transferred into a further apparatus (e.g. extruder or other high-viscosity reactor) in order to produce the thermoplastic polyurethane polymer of the invention.

In a preferred embodiment, the at least one aliphatic diol II) and the at least one aliphatic diisocyanate I) are reacted in at least one static mixer, dynamic mixer or mixer-heat transferrer to give the at least one hydroxy-terminated prepolymer.

In a further preferred embodiment, the at least one aliphatic diol II) and the at least one aliphatic diisocyanate I) are reacted in a loop reactor to give the at least one hydroxy-terminated prepolymer.

For reaction of the at least one prepolymer, preferably hydroxy-terminated prepolymer, with the at least one chain extender to give the thermoplastic polyurethane polymer, it is necessary to match the process of the invention to the exponential rise in viscosity in this phase. This is achieved preferably by using apparatuses in which the reaction product is actively moved by mechanical energy. Particular preference is given to using apparatuses in which the material surfaces clean one another—with allowance for clearance. Such apparatuses are, for example, co-rotating multi-screw extruders such as two-shaft or four-shaft extruders or ring extruders, co-rotating multi-screw extruders, co-kneaders or planetary roll extruders and rotor-stator systems. Further suitable apparatuses are single- or twin-shaft large-volume kneaders. The twin-shaft large-volume kneaders may be co- or counter-rotating. Examples of large-volume kneaders are, for example, CRP (from List Technology AG), Reacom (Buss-SMS-Canzler GmbH), Reasil (Buss-SMS-Canzler GmbH), KRC kneader (Kurimoto, Ltd). In a preferred embodiment, at least one such apparatus is combined with at least one static mixer, dynamic mixer, loop reactor or mixer-heat transferrer, in which case the at least one prepolymer, preferably hydroxy-terminated prepolymer, is produced from the at least one aliphatic diol II) and the at least one aliphatic diisocyanate I) in the static mixer, dynamic mixer, loop reactor or mixer-heat transferrer. If any of the components in the reaction mixture has a tendency to crystallize, the temperature of the mixture is kept by suitable measures within a temperature range from 30 K below to 150 K above the melting point, preferably from 15 K below to 100 K above, more preferably from 10 K below to 70 K above, the melting point of the component that melts at the highest temperature or of the reaction product of the components that melts at the highest temperature. The residence time in the static mixer, dynamic mixer, loop reactor or mixer-heat transferrer is preferably sufficiently short here that the rise in viscosity (caused by the polyaddition reaction of the reactive components with one another) does not lead to blockage of the static mixer, dynamic mixer, loop reactor or mixer-heat transferrer or any increase in pressure is limited to <50 bar, preferably <30 bar, more preferably <20 bar and most preferably <10 bar, and the mixture formed is fed to an apparatus that corresponds to the list above.

In a further preferred embodiment, the reaction of the at least one prepolymer, preferably hydroxy-terminated prepolymer, with the at least one chain extender takes place in an extruder.

In a further preferred embodiment, the preparation of the thermoplastic polyurethane polymer of the invention takes place in a combination of a loop reactor with an extruder.

In a further preferred embodiment, the preparation of the thermoplastic polyurethane polymer of the invention takes place in a combination of a static mixer, dynamic mixer, loop reactor or mixer-heat transferrer with a heated conveyor belt.

After the reaction to give the thermoplastic polyurethane polymer, it is converted to a commercial form, typically pellets. After the conversion in the final process stage, the thermoplastic polyurethane polymer is in the molten state, is comminuted in the molten state and is made to solidify by cooling, or is first made to solidify by cooling and then comminuted. This can be accomplished, for example, by the methods of strand pelletization, underwater strand pelletization, water-ring pelletization and underwater pelletization that are known to the person skilled in the art. Cooling is preferably effected with water; cooling with air or other media is also possible.

After conversion in a belt reactor, the thermoplastic polyurethane polymer of the invention can also be cooled, crushed and ground.

According to the invention, the thermoplastic polyurethane polymer of the invention thus obtained can be mixed in a solid-state mixing process and melted and pelletized again in a further extruder. This is preferable particularly when thermoplastic polyurethane polymer of the invention is cooled and ground downstream of the belt reactor because this operation also homogenizes the product form.

The preparation process of the invention can be performed continuously or batchwise, i.e. as a batchwise process or semi batchwise process.

Chain extenders used may, depending on the prepolymer formed, be organic diols, diamines and polyisocyanates. In the case of NCO-terminated prepolymers, suitable examples include organic diols and diamines each having a molecular weight of 60 g/mol to 120 g/mol. Preferred chain extenders are aliphatic diols having a molecular weight of 62 g/mol to 120 g/mol, for example ethane-1,2-diol, propane-1,2-diol, propane-1,3-diol, butane-1,2-diol, butane-1,3-diol, butane-1,4-diol, pentane-1,5-diol, hexane-1,6-diol, ethane-1,2-diamine and propane-1,3-diamine. For preparation of the thermoplastic polyurethane polymer, butane-1,4-diol is preferably used as chain extender. In the case of hydroxy-terminated prepolymers, suitable examples are polyisocyanates having a molecular weight of 140 g/mol to 170 g/mol, preferably aliphatic diisocyanates having a molecular weight of 140 g/mol to 170 g/mol, for example 1,4-diisocyanatobutane, 1,5-diisocyanatopentane, 1,6-diisocyanatohexane and 2-methyl-1,5-diisocyanatopentane. In a preferred embodiment of the for preparation of the thermoplastic polyurethane polymer, 1,6-diisocyanatohexane and/or 1,5-diisocyanatopentane is used as chain extender.

### Component B

Component B used in the thermoplastic molding composition of the invention is at least one demolding agent.

Suitable demolding agents are long-chain carboxylic acids and their soaps, esters and amides of long-chain carboxylic acids, fatty acid alcohols, polar and nonpolar ethylene waxes and ionomers derived therefrom, oxidized ethylene waxes and fatty acid alcohols, and mixtures of these substances.

Long-chain carboxylic acids (fatty acids) to be used as demolding agent are, for example, caprylic acid, perlagonic acid, capric acid, lauric acid, isotridecanoic acid, myristic acid, palmitic acid, marganic acid, stearic acid, isostearic acid, arachic acid, behenic acid, lignoceric acid, cerotic acid, montanic acid or melissic acid.

Suitable fatty acid alcohols are, for example, lauryl alcohol, isotridecyl alcohol, myristyl alcohol, palmityl alcohol, daturyl alcohol, stearyl alcohol, isostearyl alcohol, arachyl alcohol, behenyl alcohol, lignoceryl alcohol, cerotyl alcohol and montanyl alcohol.

Suitable amide waxes are, for example, compounds that can be prepared by means of a condensation reaction of long-chain carboxylic acids with mono- or polyfunctional amines. Also useful are carboxylic acids having hydroxyl groups.

Preferred long-chain carboxylic acids are those branched or linear carboxylic acids having more than 11 carbon atoms. These may be saturated or unsaturated.

Suitable examples include carboxylic acids from the group of lauric acid, isotridecanoic acid, myristic acid, palmitic acid, margaric acid, stearic acid, isostearic acid, arachic acid, behenic acid, lignoceric acid, cerotic acid, montanic acid, melissic acid, myristoleic acid, palmitoleic acid, petroselic acid, oleic acid, elaidic acid, vaccenic acid, gadoleic acid, eicosenic acid, cetoleic acid, erucic acid, nervonic acid, linoleic acid, linolenic acid, calendulic acid, eleostearic acid, punicic acid, arachidonic acid, timmodonic acid, clupanodonic acid, cervonic acid and mixtures thereof.

Preferred carboxylic acids are stearic acid and erucic acid. Particularly suitable amide waxes are ethylenebis(stearamide), stearylerucamide, erucamide.

Useful amine components include alkylamines having one or more amine groups, where the amine groups may be primary or secondary in nature and the alkyl component may be saturated or unsaturated and may contain further substituents.

Suitable ester waxes are compounds that can be prepared by means of a condensation reaction of at least one long-chain carboxylic acid with an alcohol. Suitable ester waxes are, for example, esters of the above-described carboxylic acids. Particularly suitable examples include the following carboxylic acids (fatty acids): caprylic acid, perlagonic acid, capric acid, lauric acid, isotridecanoic acid, myristic acid, palmitic acid, margaric acid, stearic acid, isostearic acid, arachic acid, behenic acid, lignoceric acid, cerotic acid, montanic acid or melissic acid.

For the alcohol component of the ester wax, for example, unsaturated or saturated alkyl compounds having at least one hydroxyl group are used, where the hydroxyl groups may be primary, secondary or tertiary. Suitable alcohols include erythritol, pentaerythritol, dipentaerythritol, tripentaerythritol, trimethylolpropane, glycerol, diglycerol, triglycerol, diglycerol, xylitol, mannitol, sorbitol, isosorbide, ethylene glycol, 1,3-propylene glycol, butane-1,4-diol, butane-2,3-diol, pentane-1,5-diol, hexane-1,6-diol, lauryl alcohol, isotridecyl alcohol, myristyl alcohol, palmityl alcohol, daturyl alcohol, stearyl alcohol, isostearyl alcohol, arachyl alcohol, behenyl alcohol, lignoceryl alcohol, cerotyl alcohol, montanyl alcohol and mixtures thereof.

Particularly suitable ester waxes are pentaerythritol tetrastearate (PETS), ethylene glycol-esterified montanic acid (Licowax™), glycerol-esterified lauric acid (POEM DL-100), and isosorbide diesters with C₈-C₁₀ fatty acids (Polysorb™ ID 46, Roquette).

Hydrolyzed waxes are compounds of a cation and at least one anion of a long-chain carboxylic acid, where the anion is obtained by deprotonation of the carboxylic acid.

Partly hydrolyzed waxes are also considered to be hydrolyzed waxes in the context of the invention. Partly hydrolyzed waxes are mixtures of neutral carboxylic acids or esters of such carboxylic acids with salts of carboxylic acid anions and cations. Examples of suitable carboxylic acids include the above-described long-chain carboxylic acids. A preferred example is a montanic acid that has been partly esterified with butylene glycol and partly hydrolyzed with calcium hydroxide (Licowax™ OP). It is likewise possible to partly esterify montanic acid with ethylene glycol and partly hydrolyze it with zinc hydroxide (Ceridust™ 5551).

Useful cations preferably include those cations that derive from the elements of the group comprising all alkali metals and alkaline earth metals, and zinc and aluminum. More preferably, the cations of the elements from the group comprising lithium, sodium, potassium, magnesium, calcium, barium, aluminum and zinc are employed.

Hydrolyzed waxes used are preferably lithium stearate, sodium stearate, potassium stearate, magnesium stearate, calcium stearate, barium stearate, aluminum stearate or zinc stearate.

The cation used is more preferably zinc. The hydrolyzed wax used is more preferably zinc stearate.

Nonpolar polyethylene waxes (or in simplified terms, nonpolar ethylene waxes) can be prepared by polymerization of ethylene or degradation of polyethylene. In the polymerization, it is also possible to use other comonomers as well as ethylene. Preferred comonomers have 2 to 10 carbon atoms and at least one double bond between two carbon atoms. Particularly preferred comonomers are propene, butene, butadiene, pentene, pentadiene, hexene and hexadiene.

Polar polyethylene waxes (or in simplified terms, polar ethylene waxes) can be prepared by oxidation of nonpolar polyethylene waxes, by polymerization of ethylene with polar comonomers, or grafting of polar unsaturated monomers onto polyethylene.

Preferred comonomers have 2 to 10 carbon atoms and at least one double bond between two carbon atoms, and a polar group. Particularly preferred comonomers are acrylic acid, acrylic esters, methacrylic esters and vinyl acetate (AC 540, Honeywell).

In addition, it is possible to use ionomers of such polar polyethylene waxes having different levels of neutralization and different cations (suitable cations having valences of 1 to 3 from the main and transition groups). For this purpose, for example, it is possible to use zinc as cation (Aclyn™ 295 A, Honeywell).

In a preferred embodiment, component B is selected from the group consisting of esters of long-chain carboxylic acids (ester waxes) and polar ethylene waxes and ionomers derived therefrom.

In a further preferred embodiment, component B is selected from the group consisting of esters, amides and soaps of long-chain carboxylic acids.

More preferably, component B is selected from the group consisting of zinc stearate, ethylenebisstearamide, and waxes containing structural units of montanic acid and ethylene glycol.

These demolding agents achieve a particularly distinct reduction in the coefficients of sticking friction and sliding friction.

### Component C

As well as components A and B, the composition as component C may contain further polymer additives or further polymeric components.

The additives may, for example, be standard additives in the field of thermoplastic technology. Of course, it may likewise be advantageous to use two or more additives of two or more types.

Suitable further polymer components are known thermoplastics or mixtures of such thermoplastics.

Components A, B and optionally C are used to produce the thermoplastic molding compounds of the invention. The thermoplastic molding compounds of the invention may be produced, for example, by mixing the respective constituents of the compositions in a known manner and melt-compounding and melt-extruding the constituents at temperatures of preferably 185° C. to 320° C., more preferably at 190° C. to 280° C., in customary apparatuses, for example internal kneaders, extruders and twin-shaft screw systems. In the context of the present application, this process is generally referred to as compounding.

What is meant by “molding compound” is thus the product obtained when components A, B and optionally C are melt-compounded or melt-extruded.

The individual constituents of the compositions can be mixed in a known manner, either successively or simultaneously, either at about 20° C. (room temperature) or at higher temperature. This means, for example, that some of the constituents can be metered in via the main intake of an extruder and the remaining constituents can be fed in later in the compounding process via a side extruder.

The invention also provides a process for producing the molding compounds of the invention.

The thermoplastic molding compounds of the invention may be used to produce moldings, films and/or fibers of any kind. The invention therefore further provides a molding, a film and/or a fiber, wherein the molding, film or fibre comprises at least one thermoplastic molding compound of the invention. These may be produced, for example, by injection molding, extrusion, especially pipe extrusion, blow-molding methods and/or melt spinning, and by 3D printing. A further form of processing is the production of moldings by thermoforming from previously produced sheets or films.

It is also possible to meter components A, B and optionally C directly into an injection molding machine or into an extrusion unit and to process them to give moldings.

The invention further provides for the use of the thermoplastic molding compound of the invention for production of a molding, preferably an injection molding or an extruded molding, a film, a fiber or a 3D-printed molding.

Preference is given to the following embodiments in particular:

1. A thermoplastic molding compound comprising
A) at least one thermoplastic polyurethane polymer obtainable by the reaction of at least the following formation components:
I) one or more aliphatic diisocyanates having a molecular weight of 140 g/mol to 170 g/mol and
II) one or more aliphatic diols having a molecular weight of 62 g/mol to 120 g/mol,
wherein the formation components used to produce the thermoplastic polyurethane polymer consist to an extent of at least 95% by weight of one or more aliphatic diisocyanates I) and one or more aliphatic diols II), based on the total mass of the formation components used, wherein the one or more aliphatic diisocyanates I) and the one or more aliphatic diols II) are used in a molar ratio in the range from 1.0:0.95 to 0.95:1.0, characterized in that the M̅_{z}/M̅_{w} ratio of the thermoplastic polyurethane polymer is within a range from 2.3 to 6, where M̅_{z} is the centrifuge-average molar mass and M̅_{w} is the mass-average molar mass, each determined by gel permeation chromatography in hexafluoroisopropanol against polymethylmethacrylate as standard,
B) at least one demolding agent.
2. The molding compound according to embodiment 1, characterized in that component B is at least one representative selected from the group consisting of long-chain carboxylic acids and soaps thereof, esters and amides of long-chain carboxylic acids, fatty acid alcohols, polar and nonpolar ethylene waxes, and ionomers, oxidized ethylene waxes and fatty acid alcohols derived therefrom.
3. The molding compound according to any of the preceding embodiments, characterized in that component B is at least one representative selected from the group consisting of esters of long-chain carboxylic acids, and polar ethylene waxes and ionomers derived therefrom.
4. The molding compound according to embodiment 2 or 3, characterized in that the esters of long-chain carboxylic acids are isosorbide esters and/or glycerol esters, and in that the polar ethylene waxes contain structural units derived from ethylene and acrylic acid.
5. The molding compound according to either of embodiments 1 and 2, characterized in that component B is at least one representative selected from the group consisting of esters, amides and soaps of long-chain carboxylic acids.
6. The molding compound according to embodiment 5, characterized in that component B is at least one representative selected from the group consisting of zinc stearate, ethylenebisstearamide, and waxes containing structural units of montanic acid and ethylene glycol.
7. The molding compound according to any of the preceding embodiments, characterized in that component B is present in a proportion of 0.01% to 1% by weight.
8. The molding compound according to any of the preceding embodiments, characterized in that component B is present in a proportion of 0.1% to 0.8% by weight.
9. The molding compound according to any of the preceding embodiments, characterized in that the M̅_{z}/M̅_{w} ratio of component A is within a range from 2.5 to 5.5.
10. The molding compound according to any of the preceding embodiments, characterized in that the M̅_{z}/M̅_{w} ratio of component A is within a range from 2.5 to 5.
11. The molding compound according to any of the preceding embodiments, characterized in that the M̅_{z} value of component A is within a range from 100 000 g/mol to 900 000 g/mol, determined by gel permeation chromatography in hexafluoroisopropanol against polymethylmethacrylate as standard.
12. The molding compound according to any of the preceding embodiments, characterized in that the M̅_{z} value of component A is within a range from 120 000 g/mol to 760 000 g/mol, determined by gel permeation chromatography in hexafluoroisopropanol against polymethylmethacrylate as standard.
13. The molding compound according to any of the preceding embodiments 1-11, characterized in that the M̅_{z} value of component A is within a range from 80 000 g/mol to 900 000 g/mol, determined by gel permeation chromatography in hexafluoroisopropanol against polymethylmethacrylate as standard.
14. The molding compound according to any of the preceding embodiments, characterized in that the M̅_{z} value of component A is within a range from 85 000 g/mol to 760 000 g/mol, determined by gel permeation chromatography in hexafluoroisopropanol against polymethylmethacrylate as standard.
15. The molding compound according to any of the preceding embodiments, characterized in that component A consists to an extent of at least 96% by weight of one or more aliphatic diisocyanates I) and one or more aliphatic diols II), based on the total mass of the polyurethane polymer.
16. The molding compound according to any of the preceding embodiments, characterized in that component A consists to an extent of at least 99.9% by weight of one or more aliphatic diisocyanates I) and one or more aliphatic diols II), based on the total mass of the polyurethane polymer.
17. The molding compound according to any of the preceding embodiments, characterized in that the one or more aliphatic diisocyanates I) are selected from the group consisting of 1,4-diisocyanatobutane, 1,5-diisocyanatopentane, 1,6-diisocyanatohexane, 2-methyl-1,5-diisocyanatopentane and/or mixtures of at least two of these, preferably 1,5-diisocyanatopentane and/or 1,6-diisocyanatohexane.
18. The molding compound according to any of the preceding embodiments, characterized in that the one or more aliphatic diisocyanates I) are selected from the group consisting of 1,5-diisocyanatopentane and/or 1,6-diisocyanatohexane.
19. The molding compound according to any of the preceding embodiments, characterized in that the one or more aliphatic diisocyanate I) is 1,6-diisocyanatohexane.
20. The molding compound according to any of the preceding embodiments, characterized in that the one or more aliphatic diols II) are selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol and/or mixtures of at least two of these, preferably propane-1,3-diol, butane-1,4-diol, hexane-1,6-diol and/or mixtures of at least two of these, more preferably butane-1,4-diol.
21. The molding compound according to any of the preceding embodiments, characterized in that the one or more aliphatic diols II) are selected from the group consisting of propane-1,3-diol, butane-1,4-diol, hexane-1,6-diol and/or mixtures of at least two of these, more preferably butane-1,4-diol.
22. The molding compound according to any of the preceding embodiments, characterized in that the one or more aliphatic diol II) is butane-1,4-diol.
23. The molding compound according to any of the preceding embodiments, characterized in that component A has a urethane group content of 40% by weight to 60% by weight, preferably of 40% by weight to 52% by weight, based on the total weight of the thermoplastic polyurethane polymer.
24. The molding compound according to any of the preceding embodiments, characterized in that component A has a urethane group content of 40% by weight to 52% by weight, based on the total weight of the thermoplastic polyurethane polymer.
25. The molding compound according to any of the preceding embodiments, characterized in that component A has a percent by weight ratio of O to N determined by means of elemental analysis of ≥1.5:1 to ≤2.6:1 and a weight ratio of N to C determined by means of elemental analysis of ≥1:10 to ≤1:3.
26. The molding compound according to any of the preceding embodiments, characterized in that component A is a semicrystalline thermoplastic polyurethane polymer.
27. The molding compound according to any of the preceding embodiments, characterized in that component A has a glass transition point of <50° C., preferably in the range between ≥0° C. and <50° C., determined by differential scanning calorimetry to DIN EN 61006 (November 2004).
28. The molding compound according to any of the preceding embodiments, characterized in that component A has a melting point of >150° C., preferably within the range between 150° C. and 200° C., determined by differential scanning calorimetry to DIN EN 61006 (November 2004).
29. The molding compound according to any of the preceding embodiments, characterized in that there is at least 100° C. between the glass transition point determined by differential scanning calorimetry to DIN EN 61006 (November 2004) and the melting point determined by differential scanning calorimetry to DIN EN 61006 (November 2004) of component A.
30. The molding compound according to any of the preceding embodiments, characterized in that the formation components used to produce component A consist to an extent of 95% by weight to 99.9% by weight of one or more aliphatic diisocyanates I) and one or more aliphatic diols II) and to an extent of 0.1% by weight to 5% by weight of one or more polyisocyanates III) and/or one or more NCO-reactive compounds IV), based on the total mass of the formation components used.
31. The molding compound according to any of the preceding embodiments, characterized in that component A includes 0.05-5% by weight of thermoset components.
32. The molding compound according to any of the preceding embodiments, characterized in that component A includes 0.5-1% by weight of thermoset components.
33. The molding compound according to any of the preceding embodiments, further comprising, as component C, at least one polymer additive other than component B and/or a further thermoplastic polymer.
34. The use of a molding compound according to any of the preceding embodiments for production of moldings.
35. A molding containing a molding compound according to any of the preceding embodiments 1 to 33.
36. A process for producing a molding compound, characterized in that components A, B and optionally C are melt-compounded or melt-extruded.

The invention is to be elucidated in detail by the examples which follow, but without restricting it thereto.

The FIGURE elucidated hereinafter and the examples serve to further elucidate the invention, but these merely constitute illustrative examples of particular embodiments, and not a restriction of the scope of the invention. The individual FIGURES show:

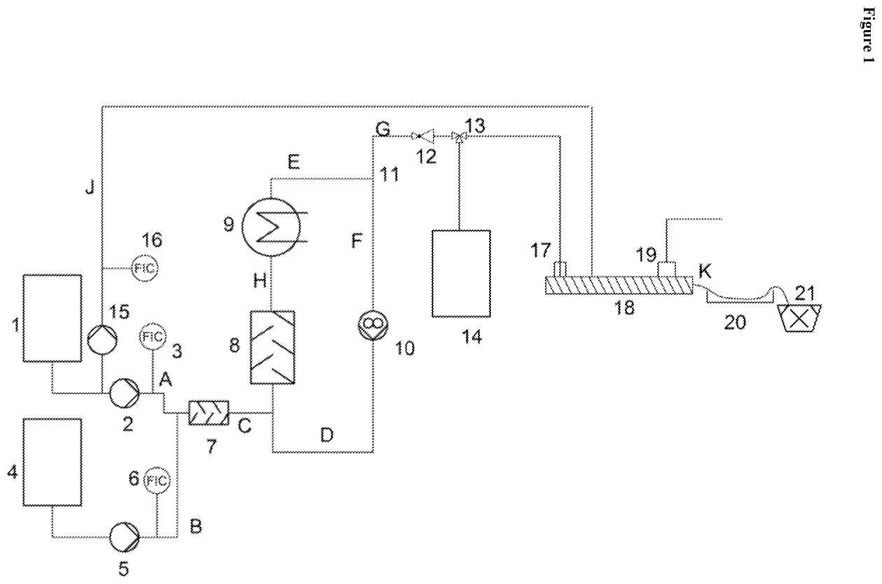

FIG. 1: Preferred embodiment of a construction for performance of a two-stage continuous preparation of a thermoplastic polyurethane of the invention, by reaction sequence in loop reactor and extruder.

### EXAMPLES

### Production of Component A

All percentages are based on weight, unless stated otherwise.

The ambient temperature of 25° C. at the time of performing the experiments is referred to as RT (room temperature).

### Raw Materials Used:

Hexamethylene 1,6-diisocyanate (HDI, purity≥99% by weight) was sourced from Covestro AG.
Butane-1,4-diol (BDO, purity≥99% by weight) was sourced from Ashland.
Hexafluoroisopropanol was sourced from flurochem in a purity of 99.9% by weight.
Potassium trifluoroacetate sourced from Aldrich, in a purity of 98% by weight.

### Gel Permeation Chromatography:

The molar masses of the polymers were determined with the aid of gel permeation chromatography (GPC). For this purpose, the sample to be analysed was dissolved in a solution of 3 g of potassium trifluoroacetate in 400 cubic centimetres of hexafluoroisopropanol (sample concentration about 2 mg/cubic centimetre). The respective GPCs were measured with the following components at a flow rate of 1 cubic centimetre/minute:
Pump: 515 HPLC pump (Waters GmbH)
Detector: Smartline 2300 RI detector (Knauer Wissenschaftliche GerAte
Columns: 1 pre-column, 1000 Å PSS PFG 7 μm, 300 Å PSS PFG 7 μm, 100 Å PSS PFG 7 μm in the sequence specified
Degassing: PSS degasser (Polymer Standards Service GmbH)
Injection volume: 100 microlitres
Temperature: 23-25° C.
Molar mass standard: Polymethylmethacrylate standard kit (PSS Polymer Standards Service GmbH)
M̅_{z} and M̅_{w} were calculated as indicated above.

### Differential Scanning Calorimetry (DSC)

Melting points and glass transition points were determined by means of DSC (differential scanning calorimetry) with a Mettler DSC 12E (Mettler Toledo GmbH, Giessen, Germany) in accordance with DIN EN 61006 (November 2004). Calibration was effected via the melt onset temperature of indium and lead. 10 mg of substance were weighed out in standard capsules. The measurement was effected by three heating runs from −50° C. to +200° C. at a heating rate of 20 K/min with subsequent cooling at a cooling rate of 20 K/min. Cooling was effected by means of liquid nitrogen. The purge gas used was nitrogen. The values reported are each based on the evaluation of the 2nd heating curve.

### Production of Component A (FIG. 1):

From a 250 litre reservoir for hexamethylene 1,6-diisocyanate 1, with the aid of a toothed ring pump 2 (from HNP, MZR 7255), a hexamethylene 1,6-diisocyanate stream A was conveyed to a static mixer 7. The throughput of the hexamethylene 1,6-diisocyanate stream A was measured by means of a mass flow meter 3 (from Bronkhorst, Mini Cori-Flow MIX, max. flow rate 12 kg/h). From a 250 litre reservoir for butane-1,4-diol 4, with the aid of a toothed ring pump 5 (from HNP, MZR 7205), a butane-1,4-diol stream B was conveyed to the static mixer 7. The throughput of the butane-1,4-diol stream was measured by means of a mass flow meter 6 (from Bronkhorst, Mini Cori-Flow MIX, max. flow rate 8 kg/h). The temperature of the hexamethylene 1,6-diisocyanate was room temperature. The temperature of the butane-1,4-diol was 40° C. In the static mixer 7 (Sulzer SMX, diameter 6 mm, ratio of length to diameter L/D=10), the hexamethylene 1,6-diisocyanate stream A and the butane-1,4-diol stream B were mixed with one another. This is stream C.

The mixed and dispersed stream C is mixed in a circulation system with a circulating polymer stream D in a static mixer 8 (static mixer equivalent to Sulzer SMX, internal diameter 34 mm, L/D=20) to give a stream H. The temperature of stream D was 182° C.

The mixed and already partly reacted stream H was guided into a temperature-controllable static mixer 9. The reaction proceeded there for the most part, and the heat of reaction that arose was removed. The temperature-controllable static mixer 9 was of similar construction to a Sulzer SMR reactor with internal crossed tubes. It had an internal volume of 1.9 litres, and a heat exchange area of 0.44 square metre. It was heated/cooled with heat carrier oil. The heating medium temperature at the inlet was 180° C.

The product stream left the temperature-controllable static mixer 9 as a largely reacted stream E with a temperature of 183° C. At a branch 11, stream E was split into two substreams F and G. The pressure of substream F was increased at a gear pump 10. Substream F became the abovementioned substream D downstream of the pump.

The gear pump 10 (from Witte Chem 25, 6-3) had a volume per cycle of 25.6 cubic centimetres and a speed of 50 per minute.

The whole circulation system was filled completely, and the polymer was largely incompressible. Therefore, the mass flow rate of stream G was identical to that of stream C. Stream G consisted of oligomer.

The whole circulation system consisted of jacketed pipelines and apparatuses that were heated with thermal oil. The heating medium temperature was 182° C.

Beyond the pressure-retaining valve 12, stream G was run past a three-way valve 13. On startup and shutdown or in the event of faults, it was possible to run said stream G to a waste vessel 14, an open 60 litre metal vat with air extraction. In regular operation, stream G was guided to an extruder 18.

From the hexamethylene 1,6-diisocyanate reservoir 1, with the aid of a micro toothed ring pump 15 (MZR 6355 from HNP), a hexamethylene 1,6-diisocyanate stream J was withdrawn. The throughput of the hexamethylene 1,6-diisocyanate stream J was measured by means of a mass flow meter 16 (from Bronkhorst, Mini Cori-Flow MIX, maximum flow rate 2 kg/h). The temperature of the hexamethylene 1,6-diisocyanate stream J was likewise room temperature. This stream was likewise guided to the extruder 18.

The extruder 18 was a ZSK 26 MC from Coperion, which was operated at temperatures of 200° C. and a speed of 66 revolutions per minute. In this extruder, stream G, by means of a venting system 17 that was operated at a reduced pressure of about 1 mbar relative to ambient pressure, was freed of any inert gases entrained with streams of matter A and B and of possible volatile reaction products. Downstream of the addition of the oligomer stream G, the hexamethylene 1,6-diisocyanate stream J was added and the reaction to give the polymer was conducted. Before the end of the extruder, the resulting polymer stream was freed of volatile constituents via a degassing operation 19. The pressure in this degassing was 200 mbar below ambient pressure. The polymer stream K was expressed through two nozzles, cooled in a water bath 20 filled with deionized water (DI water), and chopped into pellets by means of a pelletizer 21.

Table 1 shows the streams of matter that were used for preparation of component A.

### Description of the Extruder Configuration Used:

Where “elements” are mentioned in the description that follows, these may be one or more elements. It will be clear to the person skilled in the art that extruder elements, given the same outline, fulfil the same function, irrespective of subdivision.

An oligomer feed, followed by a reverse-conveying element of length 12 mm and slope 24 mm, followed by a devolatilization zone of length 84 mm with elements of slope 48 mm and 24 mm, with a housing opening length of 50 mm, followed by a reverse-conveying element of length 12 mm, followed by a feed zone with a conveying element, of length 24 mm with slope 48 mm for HDI, followed by a kneading zone of length 84 mm, a zone with conveying elements of slope 12 mm with length 240 mm, a zone with conveying elements of slope 16 mm with length 128 mm, a zone with a reverse-conveying element of slope 24 mm with length 12 mm, a zone for devolatilization with conveying elements of slope 48 mm with length 96 mm, on which the devolatilization screw was mounted at the side, and a zone with conveying elements of slope 16 mm with length 96 mm.

TABLE 1
Streams of matter in the production of component A

| | A |
|---|---|
| Stream A [kg/h] | 4.590 |
| Stream B [kg/h] | 3.000 |
| Stream J [kg/h] | 0.980 |

### Characterization of Component A Produced

The following characteristic values were found for the molar mass distribution of component A:

M̅_{z}=307554 g/mol
M̅_{w}=68990 g/mol, and so M̅_{z}/M̅_{w}=4.5

Component A has a glass transition temperature Tg of 34° C. and a melting temperature Tm of 183° C.

Component A has a urethane group content according to the calculation set out above of 48%.

### Component B:

B1: pentaerythritol tetrastearate (PETS, Loxiol™ P 8.61, Emery Oleochemicals)
B2: calcium stearate (Ceasit™ SW, Baerlocher)
B3: zinc stearate (Zincum™ PS, Baerlocher)
B4: ethylenebisstearamide (Crodamid™ EBS, Croda)
B5: stearylerucamide (Crodamid™ 212, Croda)
B6: erucamide (Crodamid™ ER, Croda)
B7: montan wax, partly esterified and partly hydrolyzed with Ca(OH)₂ (Licowax OP, Clariant)
B8: montan wax ester (Licowax E, Clariant)
B9: micronized montan wax, partly esterified and partly hydrolyzed with Zn(OH)₂ (Ceridust™ 5551, Clariant)
B10: long-chain wax ester based on carnauba wax; this is an additive produced entirely from renewable raw materials

### (Völpker Wax™ J 4418, Völpker)

B11: diglycerol fatty acid ester (POEM™ DL 100K, Riken Vitamine)

### Production and Testing of the Molding Compounds of the Invention

The components were mixed in a Werner & Pfleiderer ZSK-25 twin-screw extruder at a melt temperature of 200° C. The moldings were produced at a melt temperature of 200° C. and a mold temperature of 60° C. on an Arburg 270 E injection molding machine.

The coefficients of friction were determined using a modified injection molding machine of the Arburg-370S-800-150 type. The method is described in EP 1 377 812 B1. Sticking friction is the friction number which is derived from the force needed to set bodies that are at rest relative to one another (ram/test specimen) in motion (threshold value). Sliding friction is derived correspondingly from the constant force needed to continue the movement uniformly.

The coefficient of friction is defined as follows: FR=μ×FN or, rearranged in μ,

μ=FR/FN (FN=normal force, FR=friction force, μ=coefficient of friction).

In the case of circular motion, the following relationship applies: FR=Md/rm

(Md=torque, rm=average radius of the friction area (ring area)) and Md/rm=μ×FN
and, rearranged in μ, μ=Md/(rm×FN).

In a coefficient-of-friction mold, a disk-shaped test specimen having an outside diameter of 92 mm and a thickness of 2.6 mm was produced. At the outer edge, this had a 5 mm-high and 3 mm-broad rim on which there were flat depressions, comparable to a toothed belt disk, by means of which the torque is transmitted from the mold to the test specimen.

It permits the direct determination of the coefficient of sticking friction and coefficient of sliding fiction on a disk-shaped test specimen immediately prior to the demolding. The applicable relationship here is that the friction force is proportional to the torque. When the mold is opened, a ram connected to a torque recorder presses against the molding (friction partner) with a defined normal force FN. On the other side of the molding, the test specimen is held and set in rotation. By means of the torque measured with the ram, the coefficient of sticking friction and the coefficient of sliding friction between ram and test specimen are ascertained. Since the friction is caused by the unevenness of the faces sliding against one another (sticking), the ram was designed with an average surface roughness Ra=0.05 μm.

The materials were melted in an injection molding machine and injected at a melt temperature of 220° C. into the closed coefficient-of-friction mold with a mold wall temperature of 60° C., and held under a hold pressure of 400 bar for 15 sec. After a residual cooling time of 17 sec., the mold was opened slightly, and the coefficients of sticking and sliding friction were determined.

Tables 2a and 2b summarize molding compounds and the coefficients of friction obtained as described here.

The data show that the molding compounds of the invention have distinctly reduced coefficients of sticking and sliding friction compared to the noninventive molding compound VI. Thus, demolding characteristics in the injection mold are also improved.

TABLE 2a
Compositions of the molding compounds and their properties.

| | V1 | 1 | 2 | 3 | 4 | 5 | 6 | 7 | 8 | 9 | 10 | 11 | 12 |
|---|---|---|---|---|---|---|---|---|---|---|---|---|---|
| Component | | | | | | | | | | | | | |
| (pts. by wt.) | | | | | | | | | | | | | |
| A | 100 | 99.8 | 99.5 | 99.8 | 99.5 | 99.8 | 99.5 | 99.8 | 99.5 | 99.8 | 99.5 | 99.8 | 99.5 |
| B1 | | 0.2 | 0.5 | | | | | | | | | | |
| B2 | | | | 0.2 | 0.5 | | | | | | | | |
| B3 | | | | | | 0.2 | 0.5 | | | | | | |
| B4 | | | | | | | | 0.2 | 0.5 | | | | |
| B5 | | | | | | | | | | 0.2 | 0.5 | | |
| B6 | | | | | | | | | | | | 0.2 | 0.5 |
| Properties | | | | | | | | | | | | | |
| Coefficient of | 0.96 | 0.61 | 0.56 | 0.4 | 0.34 | 0.34 | 0.26 | 0.32 | 0.29 | 0.44 | 0.41 | 0.6 | 0.36 |
| sticking friction | | | | | | | | | | | | | |
| Coefficient of | 1.49 | 1.04 | 0.59 | 0.72 | 0.75 | 0.3 | 0.24 | 0.5 | 0.45 | 0.68 | 0.56 | 0.71 | 0.50 |
| sliding friction | | | | | | | | | | | | | |

TABLE 2b
Compositions of the molding compounds and their properties.

| | V1 | 13 | 13 | 15 | 16 | 17 | 18 | 19 | 20 | 21 | 22 |
|---|---|---|---|---|---|---|---|---|---|---|---|
| Component | | | | | | | | | | | |
| (pts. by wt.) | | | | | | | | | | | |
| A | 100 | 99.8 | 99.5 | 99.8 | 99.5 | 99.8 | 99.5 | 99.8 | 99.5 | 99.8 | 99.5 |
| B7 | | 0.2 | 0.5 | | | | | | | | |
| B8 | | | | 0.2 | 0.5 | | | | | | |
| B9 | | | | | | 0.2 | 0.5 | | | | |
| B10 | | | | | | | | 0.2 | 0.5 | | |
| B11 | | | | | | | | | | 0.2 | 0.5 |
| Properties | | | | | | | | | | | |
| Coefficient of | 0.96 | 0.34 | 0.3 | 0.28 | 0.24 | 0.27 | 0.26 | 0.28 | 0.28 | 0.35 | 0.31 |
| sticking friction | | | | | | | | | | | |
| Coefficient of | 1.49 | 0.72 | 0.63 | 0.54 | 0.50 | 0.54 | 0.46 | 0.68 | 0.56 | 0.57 | 0.49 |
| sliding friction | | | | | | | | | | | |

1: A thermoplastic molding compound comprising
A) at least one thermoplastic polyurethane polymer obtainable by the reaction of at least the following formation components:
I) one or more aliphatic diisocyanates having a molecular weight of 140 g/mol to 170 g/mol and
II) one or more aliphatic diols having a molecular weight of 62 g/mol to 120 g/mol,
wherein the formation components used for production of the thermoplastic polyurethane polymer consist to an extent of at least 95% by weight of one or more aliphatic diisocyanates I) and one or more aliphatic diols II), based on the total mass of the formation components used, where the one or more aliphatic diisocyanates I) and the one or more aliphatic diols II) are used in a molar ratio in the range from 1.0:0.95 to 0.95:1.0, characterized in that the ratio M̅_{z}/M̅_{w} of the thermoplastic polyurethane polymer is within a range from 2.3 to 6, where M̅_{z} is the centrifuge-average molar mass and M̅_{w} the mass average molar mass, in each case determined by gel permeation chromatography in hexafluoroisopropanol against polymethylmethacrylate as standard,
B) at least one demolding agent.

2: The molding compound as claimed in claim 1, characterized in that component B is at least one representative selected from the group consisting of long-chain carboxylic acids and soaps thereof, esters and amides of long-chain carboxylic acids, fatty acid alcohols, polar and nonpolar ethylene waxes, and ionomers, oxidized ethylene waxes and fatty acid alcohols derived therefrom.

3: The molding compound as claimed in claim 1, characterized in that component B is selected from the group consisting of esters, amides and soaps of long-chain carboxylic acids.

4: The molding compound as claimed in claim 1, characterized in that component B is present in a proportion of 0.01% to 1% by weight.

5: The molding compound as claimed in claim 1, characterized in that the M̅_{z} of component A is within a range from 80 000 g/mol to 900 000 g/mol, determined by gel permeation chromatography in hexafluoroisopropanol against polymethylmethacrylate as standard.

6: The molding compound as claimed in claim 1, characterized in that component A consists to an extent of at least 96% by weight of one or more aliphatic diisocyanates I) and one or more aliphatic diols II), based on the total mass of the polyurethane polymer.

7: The molding compound as claimed in claim 1, characterized in that the one or more aliphatic diisocyanates I) are selected from the group consisting of 1,4-diisocyanatobutane, 1,5-diisocyanatopentane, 1,6-diisocyanatohexane, 2-methyl-1,5-diisocyanatopentane, and mixtures of at least two of these.

8: The molding compound as claimed in claim 1, characterized in that the one or more aliphatic diols II) are selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol, and mixtures of at least two of these.

9: The molding compound as claimed in claim 1, characterized in that component A has a urethane group content of 40% by weight to 60% by weight, based on the total weight of the thermoplastic polyurethane polymer.

10: The molding compound as claimed in claim 1, characterized in that component A is a semicrystalline thermoplastic polyurethane polymer.

11: The molding compound as claimed in claim 1, characterized in that component A has a glass transition point of <50° C., determined by differential scanning calorimetry to DIN EN 61006 (November 2004).

12: The molding compound as claimed in claim 1, characterized in that component A has a melting point of >150° C., determined by differential scanning calorimetry to DIN EN 61006 (November 2004).

13: The molding compound as claimed in claim 1, characterized in that the formation components used for production of component A consist to an extent of 95% by weight to 99.9% by weight of one or more aliphatic diisocyanates I) and one or more aliphatic diols II) and to an extent of 0.1% by weight to 5% by weight of one or more polyisocyanates III) and/or one or more NCO-reactive compounds IV), based on the total mass of the formation components used.

14: The use of a molding compound as claimed in claim 1 for production of moldings.

15: A molding comprising a molding compound as claimed in claim 13.
